(19) United States
(12) Patent Application Publication
(10) Pub. No.: US 2026/0356149 A1
(43) Pub. Date: Nov. 12, 2026

(54) Wheel Suspension for a Vehicle, in Particular for a Motor Vehicle, and Vehicle

(71) Applicant: Bayerische Motoren Werke Aktiengesellschaft, Muenchen (DE)

(72) Inventors: Fabian BACHMANN, Muenchen (DE); Markus BRENNER, Muenchen (DE); Norbert DEIXLER, Unterhaching (DE); Malte FLAKE, Pfaffenhofen a.d. IIm (DE); Nino LAILACH, Baierbrunn (DE); Christoph RESCH, Ingolstadt (DE)

(21) Appl. No.: 19/102,953

(22) PCT Filed: Jul. 6, 2023
(86) PCT No.: PCT/EP2023/068681

§ 371 Date: Feb. 11, 2025

(30) Foreign Application Priority Data
Aug. 29, 2022 (DE) 10 2022 121 729.9

(51) Int. Cl. B60G 13/00; B60G 3/18

(52) U.S. Cl. CPC B60G 13/005; B60G 3/18; B60G 2202/11; B60G 2204/129; B60G 2206/71; B60G 2206/8101

(57) ABSTRACT

A wheel suspension for a vehicle has a wheel bearing, on which a vehicle wheel is to be mounted so as to rotate relative to the wheel bearing about a wheel rotation axis, a plurality of wheel links articulated to the wheel bearing to guide the wheel bearing, a support spring, supported on a first of the wheel links and thereby connected to the wheel bearing via the first wheel link, via which the wheel bearing can be supported on a structure of the vehicle in a sprung manner, and a vibration damper functionally connected parallel to the support spring and arranged completely outside the support spring, via which the wheel bearing can be supported on the structure in a damped manner. The first wheel link is arranged, viewed in the vehicle longitudinal direction, on a different side of the wheel rotation axis from at least a second of the wheel links.

### BACKGROUND AND SUMMARY

The invention relates to a wheel for a vehicle, in particular for a motor vehicle.

A multi-link axle of a two-track vehicle is disclosed in DE 10 2018 213 663 A1 with a support spring for the vehicle structure which is supported on one of the links guiding a wheel of the axle and a vibration damper which is functionally connected in parallel to the support spring. Reference is also made to DE 10 2017 215 112 A1 and DE 10 2018 214 289 A1 relative to the prior art.

It is the object of the present invention to provide a wheel suspension for a vehicle and a vehicle having at least one such wheel suspension, so that a particularly space-efficient and weight-efficient design can be implemented.

This object is achieved according to the invention by a wheel and by a vehicle having the features of the independent claim(s). Advantageous embodiments of the invention form the subject matter of the dependent claims.

A first aspect of the invention relates to a wheel suspension for a vehicle, in particular for a motor vehicle. This means that in its fully manufactured state the vehicle has the wheel suspension. The vehicle is preferably a motor vehicle, quite preferably a passenger motor vehicle. The vehicle, for example in its fully manufactured state, has an interior which is also denoted as the passenger cell or passenger compartment and which is formed or defined by a structure of the vehicle. Most preferably, the structure is configured as a self-supporting body. The structure and thus the vehicle can be supported via the wheel suspension downwardly on the ground in the vehicle vertical direction.

The wheel suspension has a wheel bearing on which a vehicle wheel of the vehicle, also simply denoted as the wheel of the vehicle, is to be mounted or is mounted so that it can rotate about a wheel rotation axis relative to the wheel bearing. The vehicle wheel is a ground contact element via which the structure and the vehicle can be supported or are supported downwardly on the aforementioned ground in the vehicle vertical direction. If the vehicle is moved along the ground while the vehicle is supported via the vehicle wheel downwardly on the ground in the vehicle vertical direction, the vehicle wheel rolls, in particular directly, on the ground and, in particular, the vehicle wheel rotates about the wheel rotation axis relative to the wheel bearing.

In particular, the wheel suspension has a wheel hub which is assigned to the wheel bearing and which is mounted on the wheel bearing so as to be rotatable about the wheel rotation axis relative to the wheel bearing. For example, the wheel hub is mounted so as to be rotatable about the wheel rotation axis relative to the wheel bearing via at least, or exactly, one rolling bearing on the wheel bearing. It is contemplated, in particular, that the vehicle wheel is connected or can be connected, in particular in a non-destructive and releasable manner, and fixedly in terms of rotation to the wheel hub.

The wheel suspension has a plurality of wheel links articulated to the wheel bearing, i.e. connected or coupled in an articulated manner to the wheel bearing, to guide the wheel bearing and thus the vehicle wheel. In other words, the wheel bearing is to be guided or is guided by means of the wheel links, also simply denoted as links, in particular relative to the structure. This is to be understood to mean, in particular, that first relative movements between the wheel bearing and the structure can be at least limited or are limited, in particular can be avoided or are avoided, by the wheel links, while the wheel links are configured, for example, to permit second relative movements between the wheel bearing and the structure in a targeted manner. In particular, in the fully manufactured state of the vehicle, the wheel links permit compression and rebound movements of the vehicle wheel, and thus of the wheel, taking place at least substantially in the vehicle vertical direction and relative to the structure, wherein the compression and rebound movements are also denoted as a whole as wheel movements. For example, the vehicle wheel is a steerable vehicle wheel. In other words, a steering system can be assigned to the vehicle wheel, the vehicle wheel being able to be steered thereby in order to be able to carry out or bring about, for example, changes in the direction of travel, lane changes and cornering of the vehicle.

During the respective wheel movement, for example, the respective wheel link is pivoted relative to the wheel bearing, in particular about a respective first pivot axis on the wheel bearing side. Moreover, for example, during the respective wheel movement the respective wheel link is pivoted relative to the structure, in particular about a respective second pivot axis on the structure side. Thus the wheel bearing is connected or can be connected via the wheel links in an articulated manner and at least indirectly to the structure. It is conceivable that the respective wheel link is connected in an articulated manner and directly to the structure. Moreover, it is conceivable to provide an axle carrier which is configured separately from the structure and is not a constituent part of the structure. The axle carrier is held, in particular mounted, in particular resiliently on the structure, for example. It is conceivable that the respective wheel link is connected in an articulated manner to the axle carrier and thus is coupled to the structure by means of the axle carrier.

The wheel suspension has a support spring, supported, in particular specifically, on one of the wheel links. The one wheel link on which the support spring is supported is also denoted as the first wheel link. The support spring is thus connected, in particular exclusively, to the wheel bearing via the first wheel link. The first wheel link is also denoted as a spring link. In particular, it is provided that the support spring is not connected by bypassing the first wheel link, so that the support spring is preferably not directly connected to the wheel bearing. The wheel bearing and thus the vehicle wheel can be supported or are supported on the structure in a sprung manner via the support spring. In particular, the wheel bearing and thus the vehicle wheel can be supported or are supported on the structure in a sprung manner via the support spring, regarding the wheel movements. Since during the respective wheel movement the wheel link is pivoted relative to the structure and relative to the wheel bearing, the respective wheel link performs, for example, a pivoting movement during the respective wheel movement. For example, the support spring is tensioned, in particular compressed, during the respective wheel movement and during the respective pivoting movement of the spring link associated therewith, whereby the support spring provides a spring force which counteracts the respective wheel movement. The support spring can comprise or can be a mechanical spring element and thus a spring element configured as a solid body, such as for example a helical spring and/or a leaf spring, in particular a transverse leaf spring. Moreover, it is conceivable that the support spring is or comprises a pneumatic spring.

The wheel suspension also has a vibration damper via which the wheel bearing and thus the vehicle wheel can be supported or are supported on the structure in a damped manner, in particular regarding the wheel movement. Thus the respective wheel movement is damped by means of the vibration damper which is also denoted as a shock absorber. For example, the vibration damper is configured as a hydraulic vibration damper, thus as a hydraulic shock absorber. The vibration damper is functionally connected parallel to the support spring.

In other words, a functional parallel connection of the support spring and the vibration damper is provided. In the wheel suspension, the first wheel link is arranged, viewed in the vehicle longitudinal direction of the vehicle, on a different side of the wheel rotation axis from at least a second of the wheel links. In other words, the first wheel link is arranged on a first side of the wheel rotation axis and the second wheel link is arranged on a second side of the wheel rotation axis facing away from the first side in the vehicle longitudinal direction. Expressed in other words, it is provided in the wheel suspension that, when viewed in the vehicle longitudinal direction of the vehicle, the first wheel link is arranged on this side of the wheel rotation axis and the second wheel link is arranged on the other side of the wheel rotation axis. The vehicle longitudinal direction is also denoted by x or as the x-direction, wherein in particular a forward direction of travel, also simply denoted as the direction of travel, in which the vehicle travels straight, i.e. forward in a straight line, coincides with the vehicle longitudinal direction.

In order to be able to implement a particularly space-efficient and weight-efficient design of the wheel suspension, according to the invention it is provided that the vibration damper is connected to the wheel bearing by bypassing all of the wheel links of the wheel suspension provided for guiding the wheel bearing of the wheel suspension. This means that the vibration damper is not connected to the wheel bearing by means of a wheel link provided for guiding the wheel bearing, but regarding its connection to the wheel bearing the vibration damper bypasses all of the wheel links of the wheel suspension provided for guiding the wheel bearing of the wheel suspension, so that for example a respective force, in particular a respective damping force, which is transferred between the vibration damper and the wheel bearing on its path from the vibration damper to the wheel bearing or vice versa, does not pass via any wheel links of the wheel suspension provided for guiding the wheel bearing.

Moreover, it is provided according to the invention that all of the wheel links of the wheel suspension provided for guiding the wheel bearing of the wheel suspension in each case, i.e. considered for the respective wheel link, are arranged on exactly one side of the vibration damper. In other words, each of the wheel links of the wheel suspension, provided for guiding the wheel bearing of the wheel suspension, is arranged in each case on exactly one side of the vibration damper. It is contemplated that at least one of the wheel links is arranged on exactly one first side of the vibration damper, while at least a second of the wheel links is arranged on exactly one second side of the vibration damper facing away from the first side of the vibration damper. For example, the second side in the vehicle longitudinal direction faces away from the first side and vice versa. In other words, at least one of the wheel links can be positioned upstream of the vibration damper and at the same time at least one other of the wheel links can be positioned downstream of the vibration damper. Thus all of the wheel links of the wheel suspension, provided for guiding the wheel bearing of the wheel suspension, are free of a through-opening penetrating the vibration damper. As a result, it is possible to implement a particularly cost-efficient, weight-efficient and space-efficient structure of the wheel suspension and thus an axle of the vehicle, which is configured for example as a multi-link axle and comprises the wheel suspension, since the respective wheel link can be configured per se in a manner which is cost-efficient, weight-efficient and space-efficient. In addition, a particularly advantageous damper ratio of the vibration damper can be implemented, wherein the damper ratio is, for example, at least approximately 1, in a range from 0.8 to 0.85 inclusive. As a result, a particularly high degree of comfort, i.e. a particularly high degree of driving comfort, can be implemented and excessively high loads acting on the vibration damper, also simply denoted as a damper, can be avoided.

The feature that the vibration damper is arranged completely outside the support spring is to be understood to mean, in particular, that the vibration damper and the support spring are components which are arranged completely externally relative to one another. This means that relative to the support spring the vibration damper is arranged completely externally from, i.e. completely outside, the support spring and the support spring is arranged completely externally from the vibration damper, i.e. completely outside the vibration damper.

The aforementioned axle comprising the wheel suspension can be, for example, a rear axle or a front axle. The axle can be a driving axle or a driven axle, so that the vehicle wheel can be a drivable vehicle wheel or driven vehicle wheel, also denoted as the drive wheel. This means that, in its fully manufactured state, the vehicle has a drive device, the vehicle wheel and thus the vehicle being able to be driven thereby. The drive device is or comprises, for example, an internal combustion engine and/or an electric machine so that the vehicle can be a hybrid vehicle or an electric vehicle, in particular a battery-electric vehicle (BEV). It is also conceivable that the axle is a non-drivable axle or non-driven axle, so that the vehicle wheel is, for example, a non-drivable vehicle wheel or non-driven vehicle wheel.

In order to be able to keep the installation space requirement, the weight and the costs of the wheel suspension particularly low, in one embodiment it is provided that all of the wheel links of the wheel suspension provided for guiding the wheel bearing of the wheel suspension are configured as link rods. This is to be understood to mean, in particular, the following: the respective wheel link has for example, in particular, exactly one first bearing region in which or via which the respective wheel link is connected in an articulated manner to the wheel bearing, in particular is mounted on the wheel bearing. Moreover, for example, the respective wheel link has, in particular, exactly one second bearing region in which or via which the respective wheel link can be connected or is connected in an articulated manner, i.e. can be mounted or is mounted in an articulated manner, on the structure, directly on the structure or on the axle carrier. In other words, for example, the respective wheel link preferably has, in particular, exactly two bearing regions, namely the first bearing region and the second bearing region. It is preferably provided that the bearing regions are located on a common straight line. Thus at least, or exactly, one straight line which intersects both the first bearing region and the second bearing region is present. A particularly space-efficient, weight-efficient and cost-efficient structure of the respective wheel link per se can be implemented thereby.

Since the support spring is supported against, in particular on, the first wheel link and thus connected to the wheel bearing by means of the first wheel link, the first wheel link is also denoted as a spring link. The first spring link, for example, is a camber link. The second link can be, for example, a trailing arm.

A further embodiment is characterized in that the second wheel link and the vibration damper are connected in an articulated manner to a common structural element of the wheel bearing which is configured in one piece. Thus a connection node is provided, for example, by the structural element. The feature that the structural element is configured in one piece is to be understood to mean that the structural element is formed from a single piece, so that the structural element is configured by a monoblock or as a monoblock. Expressed in other words, the structural element is not composed, for example, of a plurality of elements which are configured separately from one another and connected together but the structural element is formed from a single piece. This means, in particular, that the structural element is formed by an integral body which is manufactured in one piece and thus is integrally manufactured. A particularly space-efficient, weight-efficient and cost-efficient design can be implemented thereby.

In order to keep the installation space requirement, the costs and the weight of the wheel suspension particularly low, in a further embodiment of the invention it is provided that the first wheel link (spring link) is connected in an articulated manner to the structural element which is configured in one piece.

Preferably, the structural element is manufactured by primary forming, whereby a particularly space-efficient, weight-efficient and cost-efficient design can be formed.

The primary forming can be forging. In order to be able to keep the weight particularly low, however, in a further embodiment of the invention it is provided that the primary forming is casting so that the structural element is manufactured by casting and thus is also configured as a cast component, also denoted as the cast component.

In order to be able to keep the weight of the wheel suspension particularly low, in a further embodiment of the invention it is provided that the structural element is formed from a light metal, in particular a light metal casting.

The light metal is preferably aluminum, so that the structural element can preferably be configured as an aluminum cast part.

It has also been shown to be particularly advantageous if the first wheel link and/or the second wheel link is configured as a forged link. Moreover, all of the wheel links of the wheel suspension provided for guiding the vehicle wheel of the wheel suspension may be configured as forged links. As a result, a particularly space-efficient design can be formed.

In order to be able to keep the weight and the costs in a particularly small framework, in a further embodiment of the invention it is provided that the first wheel link and/or the second wheel ink is configured as a sheet metal link, in particular in a shell design. In particular, all of the wheel links of the wheel suspension which are provided for guiding the vehicle wheel of the wheel suspension may be configured as sheet metal links, in particular in a shell design.

A second aspect of the invention relates to a vehicle, which is preferably configured as a motor vehicle, in particular as an automobile and quite particularly as a passenger motor vehicle, which comprises at least one wheel suspension according to the first aspect of the invention. Advantages and advantageous embodiments of the first aspect of the invention are to be regarded as advantages and advantageous embodiments of the second aspect of the invention and vice versa.

Further details of the invention are found in the following description of a preferred exemplary embodiment with the accompanying drawings.

### BRIEF DESCRIPTION OF THE DRAWINGS

FIG. 1 is a schematic perspective view of a wheel suspension for a vehicle;

FIG. 2 is a further schematic perspective view of the wheel suspension; and

FIG. 3 is a further schematic perspective view of the wheel suspension.

Elements which are the same or functionally the same are provided in the figures with the same reference signs.

### DETAILED DESCRIPTION OF THE DRAWINGS

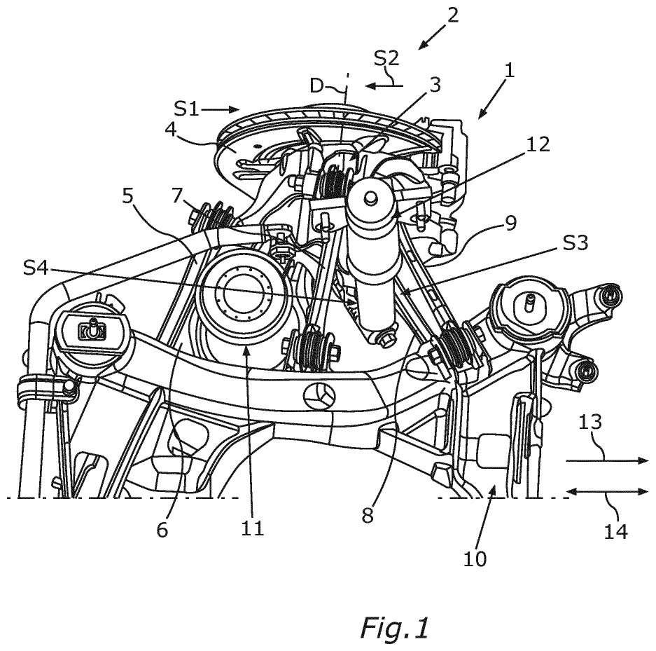

FIG. 1 shows a wheel suspension 1 for a vehicle in a schematic perspective view. The vehicle has in its fully manufactured state at least, or exactly, two vehicle axles which are arranged successively in the vehicle longitudinal direction of the vehicle, and thus one behind the other, and which are also simply denoted as axles. The respective vehicle axle has at least, or exactly, two vehicle wheels which are also simply denoted as wheels. The respective vehicle wheels of the respective vehicle axle are arranged on opposing sides of the vehicle in the vehicle transverse direction of the vehicle. The vehicle wheels are ground contact elements via which the vehicle can be supported or is supported downwardly on the ground in the vehicle vertical direction of the vehicle, the interior of the vehicle, also denoted as the passenger cell or passenger compartment, being formed or defined by a structure of the vehicle which is preferably configured as a self-supporting body. For example, a wheel suspension, such as the wheel suspension 1, is provided for each vehicle wheel. One of the vehicle axles is a front axle, so that the other vehicle axle is a rear axle which is arranged downstream of the front axle in the vehicle longitudinal direction. For example, the wheel suspension 1 is a constituent part of the aforementioned rear axle. The vehicle wheels of the front axle are also denoted as front wheels and the vehicle wheels of the rear axle are also denoted as rear wheels. The vehicle axle having the wheel suspension 1 is denoted in FIG. 1 by 2.

The wheel suspension 1 has a wheel bearing 3 on which one of the vehicle wheels of the vehicle axle 2 is to be mounted or is mounted so that it can rotate relative to the wheel bearing 3 about a wheel rotation axis D. When the vehicle wheel is discussed hereinafter, unless specified otherwise, this is understood to mean the vehicle wheel which is to be mounted or is mounted on the wheel bearing 3 so that it can rotate relative to the wheel bearing 3 about the rotation axis D. In FIG. 1 it is possible to identify a brake disk 4, which is assigned to the vehicle wheel, of a service brake of the vehicle which is configured as a friction brake, wherein the friction brake is configured as a disk brake. The vehicle and thus the vehicle as a whole can be braked by braking the brake disk 4.

The wheel suspension 1 has a plurality of wheel links 5, 6, 7, 8 and 9 which are also denoted as links, wheel guide links or wheel guide elements. In the exemplary embodiment shown in the figures, the wheel suspension 1 has exactly five wheel links, namely the wheel links 5, 6, 7, 8 and 9. Thus the vehicle axle 2 is configured as a multi-link axle. The wheel bearing 3 is to be guided or is guided relative to the structure by means of the wheel links 5, 6, 7, 8 and 9.

In the exemplary embodiment shown in the figures, the wheel suspension also has an axle carrier 10 which is configured separately from the structure and is held, in particular elastically mounted, on the structure. The respective wheel links 5, 6, 7, 8 and 9 are respectively connected in an articulated manner, on the one hand, in particular at one end, to the wheel bearing 3 and respectively connected in an articulated manner, on the other hand, in particular at the other end, to the axle carrier 10 so that first undesired relative movements between the wheel bearing 3 and the axle carrier 10 and thus between the wheel bearing 3 and the structure are at least limited or prevented by the wheel links 5, 6, 7, 8 and 9, while the wheel links 5, 6, 7, 8 and 9, also simply denoted as links, permit compression and rebound movements of the wheel bearing 3 and thus of the vehicle wheel taking place, in particular, at least substantially in the vehicle vertical direction and relative to the structure and relative to the axle carrier 10. The compression and rebound movements are also denoted as a whole as wheel movements. The respective link is pivoted relative to the wheel bearing 3 and relative to the axle carrier 10 during the, or due to, the respective wheel movement. This means that the respective link performs a respective pivoting movement relative to the wheel bearing 3 and relative to the axle carrier 10 during the, or due to, the respective wheel movement.

The wheel suspension 1 has a support spring 11 via which the wheel bearing 3 and thus the vehicle wheel can be supported or are supported in a sprung manner on the structure, in particular regarding the respective wheel movement. In the exemplary embodiment shown in the figures, the support spring 11 is configured as a pneumatic spring. It can be identified in FIG. 1 that the support spring 11 is supported against, in particular on, the wheel link 6, in particular at least substantially in the vehicle vertical direction, so that the support spring 11 is connected to the wheel bearing 3 by means of the wheel link 6. Conversely, the wheel bearing 3 is coupled to the support spring 11 by means of the wheel link 6 and thus can be supported or is supported in a sprung manner on the structure via the wheel link 6 and the support spring 11 regarding its respective wheel movement. The wheel link 6 is also denoted as a spring link.

The wheel suspension 1 also has a vibration damper 12 which is also denoted as a damper or shock absorber. Preferably, the vibration damper 12 is a hydraulic vibration damper, i.e. a hydraulic shock absorber. The wheel bearing 3 and thus the vehicle, in particular, can be supported or are supported via the vibration damper 12 in a damped manner on the structure, in particular regarding their respective wheel movement. It is contemplated that the support spring 11 which is supported on, in particular coupled to, on the one hand, in particular directly, the wheel link 6, can be supported, on the other hand, in particular directly, on the structure, in particular is coupled to the structure. It is also contemplated that the vibration damper 12 is supported, in particular directly, on the structure, in particular is coupled to the structure.

The wheel link 8, for example, is also denoted as a second wheel link. For example, the wheel link 8 is a trailing arm. The wheel link 9 is also denoted, for example, as a guide link or is a guide link. The wheel link 7 is configured in the present case as a transverse link. The wheel link 5 is preferably a track link or is also denoted as a track link. The wheel link 6 is, for example, a camber link or is also denoted as a camber link.

In the wheel suspension 1, when viewed in the vehicle longitudinal direction of the vehicle, the wheel link 6 is arranged on a different side of the wheel rotation axis D from the wheel link 8 and also, for example, from the wheel link 9. The vehicle longitudinal direction of the vehicle is illustrated in FIG. 1 by a double arrow 14, the forward direction of travel thereof, also denoted as the direction of travel, being illustrated by an arrow 13. In the wheel suspension 1 a plurality of links and thus at least, or exactly, two of the links, one thereof being the wheel link 6, are arranged on a first side S1 of the wheel rotation axis D, and a plurality of links and thus at least, or exactly, two of the links, one thereof being the wheel link 8, are arranged on a second side S2 of the rotation axis D, wherein the second side S2 faces away from the first side S1 in the vehicle longitudinal direction of the vehicle. In other words, when viewed in the vehicle longitudinal direction, the wheel link 6 (spring link) is arranged on this side of the vehicle rotation axis D, while the wheel link 8 is arranged on the other side of the wheel rotation axis D. In the specific exemplary embodiment shown in the figures, for example, the wheel links 5, 6 and 7, when viewed in the vehicle longitudinal direction, are arranged on this side of the wheel rotation axis D, while the wheel links 8 and 9, when viewed in the vehicle longitudinal direction, are arranged on the other side of the rotation axis D and thus on the second side S2. It can be identified by way of the arrow 13 that the wheel link 8 and in the present case also the wheel link 9, when viewed in the vehicle longitudinal direction, are arranged upstream of the wheel rotation axis D, wherein the wheel links 5, 6 and 7, when viewed in the vehicle longitudinal direction, are arranged downstream of the wheel rotation axis D relative to the forward direction of travel. Expressed in other words, the wheel links 8 and 9 at the front in the vehicle longitudinal direction, and thus when viewed in the forward direction of travel, are adjacent to the wheel rotation axis D, and the wheel rotation axis D at the front in the vehicle longitudinal direction, and thus when viewed in the forward direction of travel, is adjacent to the wheel links 5, 6 and 7. Moreover, the vibration damper 12 is arranged completely outside the support spring 11 and the support spring 11 is arranged completely outside the vibration damper 12. The support spring 11 and the vibration damper 12 are connected in parallel to one another.

In order to implement a particularly space-efficient, weight-efficient and cost-efficient design of the wheel suspension 2, as can be identified particularly clearly from viewing FIGS. 1 to 3 together, in the wheel suspension 1 it is provided that the vibration damper 12 is connected, in particular in an articulated manner, to the wheel bearing 3 by bypassing all of the wheel links 5, 6, 7, 8, and 9 of the wheel suspension 1 provided for guiding the wheel bearing of the wheel suspension 1, and by bypassing the support spring 11. The support spring 11 is connected to the wheel bearing 3 by bypassing the vibration damper 12 and by means of the wheel link 6. Moreover, in the wheel suspension 1 it is provided that all of the wheel links 5, 6, 7, 8 and 9 of the wheel suspension 1 provided for guiding the wheel bearing 3 of the wheel suspension 1 are arranged in each case on exactly one side of the vibration damper 12. In the exemplary embodiment shown in the figures, the wheel links 8 and 9 are arranged on a first side S3 of the vibration damper 12, wherein in the present case the first side S3 at the front, in the forward direction of travel, thus faces in the forward direction of travel. The wheel link 6 and in the present case the wheel links 5 and 7 are arranged on a second side S4 of the vibration damper 12, wherein the side S4 faces away from the side S3 in the vehicle longitudinal direction. In the present case, the side S4 faces to the rear in the vehicle longitudinal direction and thus counter to the forward direction of travel. While the wheel links 8 and 9 relative to the sides S3 and S4, in particular relative to all of the sides of the vibration damper 12, are arranged only on the side S3, the wheel link 6, and in the present case also the wheel links 5 and 7, relative to the sides S3 and S4 and in particular relative to all of the sides of the vibration damper 12, are arranged only on the side S4. The wheel links 8 and 9 are thus arranged, so to speak, upstream of the damper, while the wheel links 5, 6 and 7 are arranged downstream of the damper.

In the exemplary embodiment shown in the figures, it is also provided that all of the wheel links 5, 6, 7, 8 and 9 of the wheel suspension 1 provided for guiding the wheel bearing 3 of the wheel suspension 1 are configured as link rods.

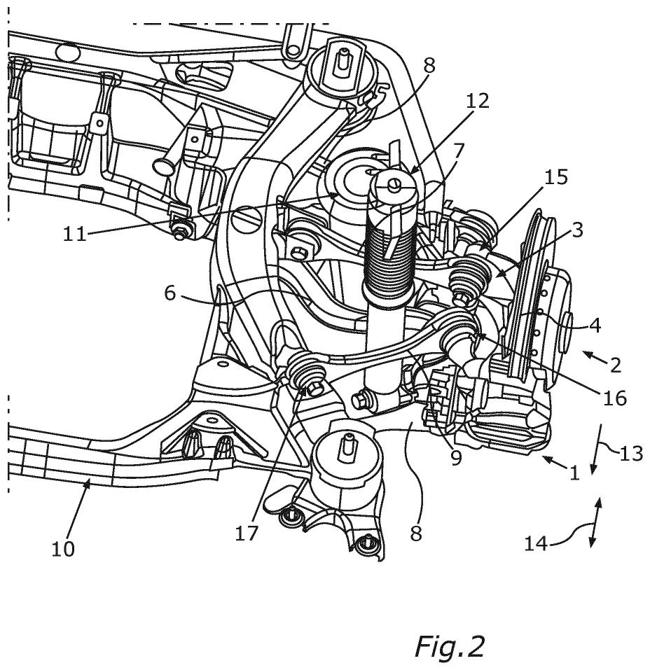

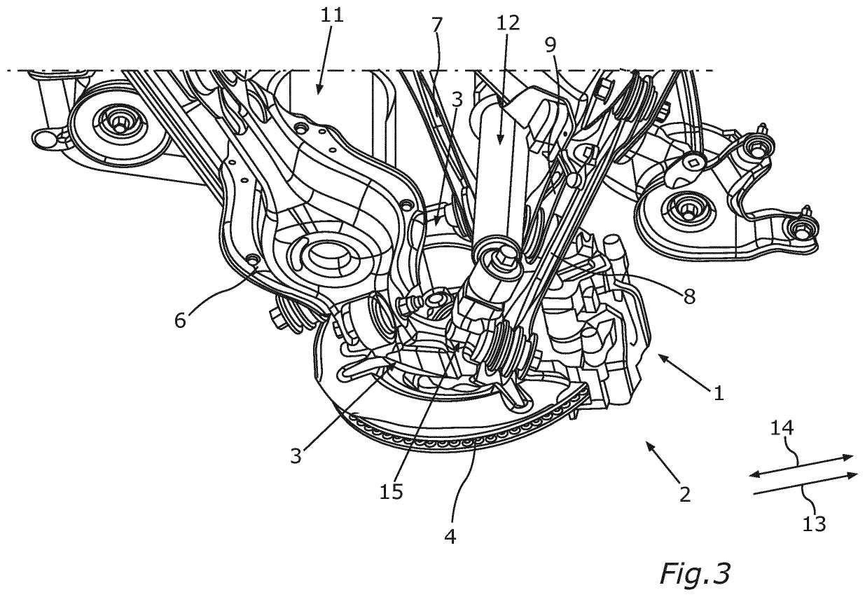

It can be identified particularly clearly from FIG. 3 that the wheel link 8 and the vibration damper 12 are connected, in particular in an articulated manner, to a common structural element 15 of the wheel bearing 3 which is configured in one piece. The wheel link 6 is also connected, in particular in an articulated manner, to the structural element 15 which is configured in one piece. The structural element 15, in particular the wheel bearing 3 as a whole, is manufactured by casting and thus is configured as a cast part. Preferably, the structural element 15, in particular the wheel bearing 3 as a whole, is formed from a light metal, in particular aluminum, so that preferably the structural element 15, in particular the wheel bearing 3 as a whole, is configured as an aluminum cast part. All of the remaining wheel links 5, 7 and 9, as can be identified particularly clearly in FIG. 2, are connected, in particular in an articulated manner, to the structural element 15 of the wheel bearing 3 which is configured in one piece, so that in the exemplary embodiment shown in the figures, it is provided that all of the wheel links 5, 6, 7, 8 and 9 of the wheel suspension 1 provided for guiding the wheel bearing 3 of the wheel suspension 1 are connected, in particular in an articulated manner, to the structural element 15 which is configured in one piece. In the exemplary embodiment shown in the figures, all of the wheel links 5, 6, 7, 8 and 9 of the wheel suspension 1 provided for guiding the wheel bearing 3 of the wheel suspension 1 are configured as link rods and also as sheet metal links, in particular in a shell design.

It can be identified particularly clearly from the example of the wheel link 9 in FIG. 2, that the wheel link 9 has exactly two bearing regions 16 and 17 via which the wheel link 9 is coupled, in particular in each case in an articulated manner, to the wheel bearing 3 and the axle carrier 10.

In particular, the wheel link 9 has exactly one bearing region 16 via which the wheel link 9 is coupled, in particular in an articulated manner, to the wheel bearing 3. Moreover, the wheel link 9 has exactly one bearing region 17 via which the wheel link 9 is coupled in an articulated manner to the axle carrier 10 or to the structure. The embodiments of the wheel link 9 above and below, in particular regarding the bearing regions 16 and 17, can also be easily transferred to the other wheel links 5, 6, 7 and 8 of the wheel suspension 1. The bearing regions 16 and 17 are located on a common straight line. Thus the wheel link 9 is configured as a particularly cost-efficient link rod.

### REFERENCE SIGNS

1 Wheel suspension
2 Vehicle axle
3 Wheel bearing
4 Brake disk
5 Wheel link
6 Wheel link
7 Wheel link
8 Wheel link
9 Wheel link
10 Axle carrier
11 Support spring
12 Vibration damper
13 Arrow
14 Double arrow
15 Structural element
16 Bearing region
17 Bearing region
S1 Side
S2 Side
S3 Side
S4 Side

1. -10. (Canceled)

11. A wheel suspension for a vehicle, comprising:
a wheel bearing on which a vehicle wheel of the vehicle is to be mounted so as to rotate relative to the wheel bearing about a wheel rotation axis;
a plurality of wheel links articulated to the wheel bearing to guide the wheel bearing;
a support spring supported on a first of the wheel links and thereby connected to the wheel bearing via the first wheel link, via which support spring the wheel bearing is supportable on a structure of the vehicle in a sprung manner; and
a vibration damper functionally connected parallel to the support spring and arranged completely outside the support spring, via which vibration damper the wheel bearing is supportable on the structure in a damped manner, wherein
the first wheel link is arranged, viewed in a vehicle longitudinal direction, on a different side of the wheel rotation axis from at least a second of the wheel links,
the vibration damper is connected to the wheel bearing by bypassing all of the wheel links of the wheel suspension provided for guiding the wheel bearing of the wheel suspension, and
each of the wheel links of the wheel suspension provided for guiding the wheel bearing of the wheel suspension is arranged on exactly one side of the vibration damper.

12. The wheel suspension according to claim 11, wherein
all of the wheel links of the wheel suspension provided for guiding the wheel bearing of the wheel suspension are configured as link rods.

13. The wheel suspension according to claim 11, wherein
the second wheel link and the vibration damper are connected to a common structural element of the wheel bearing which is configured in one piece.

14. The wheel suspension according to claim 13, wherein
the first wheel link is also connected to the common structural element which is configured in one piece.

15. The wheel suspension according to claim 13, wherein
the common structural element is a primary formed structural element.

16. The wheel suspension according to claim 15, wherein
the primary formed structural element is a cast structural element.

17. The wheel suspension according to claim 13, wherein
the structural element is formed of a light metal.

18. The wheel suspension according to claim 11, wherein
the first wheel link and/or the second wheel link is configured as a forged link.

19. The wheel suspension according to claim 11, wherein
the first wheel link and/or the second wheel link is configured as a sheet metal link.

20. A vehicle comprising at least one wheel suspension according to claim 11.
